(19) United States
(12) Patent Application Publication
(10) Pub. No.: US 2006/0262964 A1
(43) Pub. Date: Nov. 23, 2006

(54) Method and device for verifying the identity of an object

(75) Inventors: Constant Paul Marie Josef Baggen, Eindhoven (NL); Jasper Goseling, Enschede (NL); Antonius Hermanus Maria Akkermans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIS N.V., 5621 BA EINDHOVEN (NL)

(21) Appl. No.: 10/557,971

(22) PCT Filed: May 6, 2004
(86) PCT No.: PCT/IB04/01647

§ 371 Date: Nov. 17, 2005

(30) Foreign Application Priority Data
May 21, 2003 (EP) 03300017.5

(51) Int. Cl. G06K 9/00; G06K 9/62

(52) U.S. Cl. 382/115; 382/228

(57) ABSTRACT

The invention applies to the verification of the identity of an object based on measurements of a physical characteristic of said object. In an enrollment phase, an object with known identity is measured. The resulting enrollment measurement is stored for future reference. Then in the verification phase, an object presented for verification is measured, and the verification measurement is compared with the enrollment measurement to decide whether or not the two measurements originate from the same object. According to the invention, the enrollment and the verification measurements are modeled as two realizations of a first random variable affected by an enrollment noise and a verification, noise respectively, said enrollment and verification noises being a realization of a second and a third random variable, respectively, said first, second and third random variables having known distributions.

### FIELD OF THE INVENTION

The invention relates to a verification method of verifying the identity of an object from a verification measurement which characterizes said object, and from a pre-stored enrollment measurement.

The invention also relates to an identification device having verification means for verifying the identity of a person who is using said identification device from an enrollment measurement stored in the identification device, and from a verification measurement which characterizes said person.

The invention also relates to a reading/writing device for reading/writing data from/onto a record medium, said reading/writing device having verification means for verifying the identity of the record medium that is read/written by said reading/writing device from an enrollment measurement, and from a verification measurement which characterizes said record medium.

The invention applies to objects that can be uniquely identified by at least one of their physical characteristics. The object whose identity is to be verified may be a device (for instance a storage medium) or a human being. For a storage medium, the physical characteristic to be measured could be the shape of the track of the storage medium. For a human being, the physical characteristic to be measured is usually referred to as biometrics. For example, the biometric to be measured may be a fingerprint, a facial feature, . . . etc.

### BACKGROUND OF TIE INVENTION

The report “Smart cards & Biometrics—Forget about PINs” by Dr Norbert Pohlmann published in Business Briefing: Global Infosecurity 2002 describes a system in which a biometric template of an authorized user is deposited on a smart card. A person who claims to be the authorized user of the smart card has to present his biometric. The presented biometric is received by the smart card and compared with the template biometric stored on the card.

One object is measured in such systems during a first phase usually referred to as enrollment phase. The measurement referred to as enrollment measurement is stored for future reference.

During a second phase usually referred to as verification phase, a measurement referred to as verification measurement is made from an object that may be the same object or a different object.

Then the enrollment and the verification measurements are compared in order to decide whether or not they originate from the same object.

In this situation, there is no database available for storing the enrollment measurements for all objects. This means that all measurements that are different from the one to be matched against are completely unknown.

### SUMMARY OF THE INVENTION

One object of the present invention is to propose a verification method well adapted to such situations.

Another object of the invention is to propose an identification device in which such a verification method is implemented.

Another object of the invention is to propose a device for reading/writing data from/onto a record medium wherein such a verification method is implemented.

These objects are achieved with a verification method as defined in claims 1 to 3, an identification device as defined in claims 4 to 6, and a reading/writing device as defined in claim 8 or 9.

According to the invention, the enrollment measurement and the verification measurement are modeled as a first and a second realization of a first random variable affected by an enrollment noise and a verification noise, respectively, said enrollment noise being a realization of a second random variable, said verification noise being a realization of a third random variable, said first, second, and third random variables having known distributions.

This choice is based on the recognition that:
in the situations where there is no a priori knowledge on the measurements performed, a measurement which characterizes an object is a specific realization of a random variable,
in practice the measurements are always affected by noise both during the enrollment phase and during the verification phase.

This means that the enrollment measurement xₑ and the verification measurement xᵥ are written:
xₑ=sₖ+nₑ
xᵥ=s_{q}+nᵥ

where sₖ and s_{q} are realizations of a random variable S,
nₑ is the enrollment noise affecting the realization sₖ,
nᵥ is the verification noise affecting the realization s_{q}.
   (throughout the text capital letters are used when referring to variables and lower-case letters are used when refering to specific values assumed by a variable).

This model being set, the decision to be taken is whether sₖ and s_{q} are the same realizations of the random variable S. According to the invention, this is achieved by:
calculating, for the enrollment measurement xₑ and the verification measurement xᵥ, the value of a function g of the ratio Λ(Xₑ,Xᵥ) between the joint probability density functions of two variables Xₑ and Xᵥ under a first hypothesis where said first and second realizations of the first random variable are the same (ƒ₁(Xₑ,Xᵥ)) and under a second hypothesis where said first and second realizations are different (ƒ₀(Xₑ,Xᵥ)),
taking a decision whether or not the enrollment measurement xₑ and the verification measurement xᵥ are from the same object by comparing the calculated value g[Λ(xₑ,xᵥ)] with a threshold value.

Advantageously the function g is a logarithmic function which reduces computations significantly.

It is to be noted that in certain situations the enrollment noise may be reduced by means of multiple measurements in the enrollment phase. There are, however, situations in which it is not possible to make multiple enrollment measurements, and if multiple enrollment measurements are made, a certain inaccuracy always remains. Therefore, in all cases, taking into account the enrollment noise provides a significant improvement of the performance of the verification process.

### BRIEF DESCRIPTION OF THE DRAWINGS

These and other aspects of the invention will be further described with reference to the following drawings, in which:

FIG. 1 is a schematic diagram illustrating a model used in a verification method according to the invention,

FIG. 2 is a block diagram depict the main steps of a verification method according to the invention,

FIGS. 3 and 4 illustrate the performance of a verification method according to the invention,

FIG. 5 is a schematic representation of a system comprising an example of an identification device according to the invention and a reader for reading such an identification device,

FIG. 6 is a schematic representation of a system comprising an example of a reading/writing device according to the invention and a record medium whose identity is to be verified by said reading/writing device.

### DETAILED DESCRIPTION OF THE INVENTION

The present invention applies to the verification of the identity of an object based on measurements of at least one physical characteristic of said object. Such a verification process is usually described by referring to two phases: an enrollment phase and a verification phase.

In the enrollment phase, an object with known identity is measured. Such a measurement referred to as enrollment measurement is stored for future reference. In the verification phase, an object is presented for verification. A measurement of the presented object is made which is referred to as verification measurement. The verification measurement is then compared with the enrollment measurement to decide whether or not the two measurements originate from the same object.

The word “object” in the description and in the claims refers to either devices or living beings.

According to the Invention:

a physical characteristic used to identify an object is modeled as the realization of a random variable S distributed according to a known distribution Pₛ,
both the enrollment and the verification measurement of a physical characteristic of an object are supposed to be noisy,
the enrollment noise is modeled as a realization nₑ of a random variable Nₑ having a known distribution P_{Ne},
the verification noise nᵥ is modeled as a realization of a random variable Nᵥ having a known distribution P_{Nv},
S, Nₑ and Nᵥ are assumed to be independent random variables.

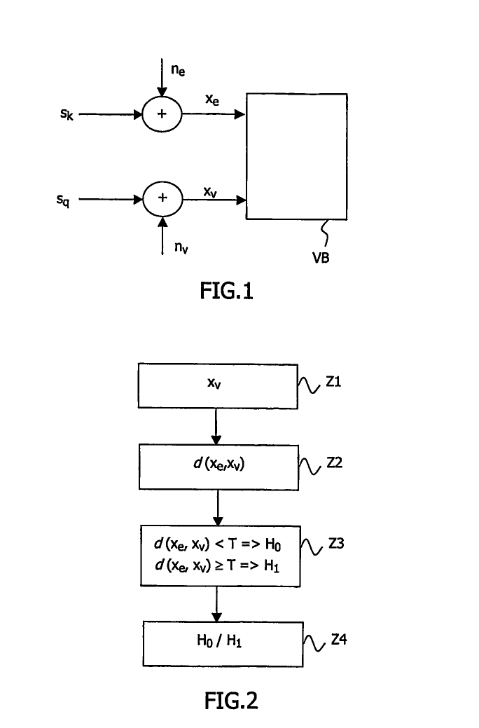

This model is schematically represented in FIG. 1. In FIG. 1, an object k is measured in the enrollment phase and an object q is measured in the verification phase. The enrollment measurement xₑ and the verification measurement xᵥ are written as:
xₑ=sₖ+nₑ
xᵥ=s_{q}+nᵥ

A verifier VB is in charge of deciding whether sₖ and s_{q} are the same realizations of the random variable S, based on the enrollment measurement xₑ and the verification measurement xᵥ. This can be formulated as a decision between two hypotheses:
a first hypothesis H₀ in which the objects k and q are different,
a second hypothesis H₁ in which the objects k and q are the same.
   Deciding between these two hypotheses can be done by:
calculating the value of the likelihood ratio

$$Λ ( {X}_{e} , {X}_{v} ) = \frac{{f}_{1} ( {X}_{e} , {X}_{v} )}{{f}_{0} ( {X}_{e} , {X}_{v} )}$$

for Xₑ=xₑ and Xᵥ=xᵥ where ƒ₁(Xₑ,Xᵥ) is the joint probability density function for the variables Xₑ and Xᵥ under hypothesis H₁, that is when sₖ and s_{q} are the same realization of the random variable S, ƒ₀(Xₑ,Xᵥ) is the joint probability density function for the variables Xₑ and Xᵥ under hypothesis H₀, that is when sₖ and s_{q} are different realizations of the random variable S,
taking a decision whether or not the enrollment measurement xₑ and the verification measurement xᵥ are from the same object by comparing the calculated value Λ(xₑ,xᵥ) with a threshold value.

Alternatively, any monotonic function g of the likelihood ratio Λ may be used as a decision function d instead of the likelihood ratio itself.

FIG. 2 is a block diagram depicting the steps of a verification method according to the invention.

In step Z1, a verification measurement xᵥ is made on an object q.

In step Z2, the value d(xₑ,xᵥ) of the decision function d is computed for the verification measurement xᵥ made in step Z1 and an enrollment measurement xₑ.

In step Z3, the computed value d(xₑ,xᵥ) is compared with a threshold T as follows:
if d(xₑ,xᵥ)<T, then hypothesis H₀ is chosen,
if d(xₑ,xᵥ)≧T, then hypothesis H₁ is chosen.

In step Z4, the decision resulting from step Z3 (hypothesis H₀ or hypothesis H₁) is output.

A preferred decision function d to be used in step Z3 will now be derived by way of example for the case in which all signals are vectors of independent Gaussian distributed random variables. This preferred decision function is the logarithm of the likelihood ratio. As will be apparent in the following, taking the logarithm of the likelihood ratio as a decision function is advantageous because it simplifies the calculations. It is to be understood that this preferred example is not restrictive and that the invention applies to any other monotonic function g of the likelihood ratio and to other forms of distributions.

The logarithm of the likelihood ratio will first be derived for Gaussian distributed scalars, and then for vectors of independent identically and Gaussian distributed scalars.

Logarithm of the Likelihood Ratio for Gaussian Distributed Scalars

It is assumed that verifier VB has full knowledge of all the distributions:
Pₛ is a known Gaussian distribution with mean μₛ and variance σₛ²,
P_{Ne} is a known Gaussian distribution with mean μₙₑ and variance σₙₑ²,
P_{Nv} is a known Gaussian distribution with mean μₙᵥ and variance σₙᵥ².

Generally speaking, the bivariate Gaussian probability density function under hypothesis Hⱼ is in the form:

$${f}_{j} ( {X}_{e} , {X}_{v} ) = \frac{1}{2 {πσ}_{xe} {σ}_{xv} \sqrt{1 - {ρ}_{j}^{2}}} * exp [ - \frac{{{σ}_{xv}^{2} ( {X}_{e} - {μ}_{xe} )}^{2} - 2 {ρ}_{j} {σ}_{xe} {σ}_{xv} ( {X}_{e} - {μ}_{xe} ) ( {X}_{v} - {μ}_{xv} ) + {{σ}_{xe}^{2} ( {X}_{v} - {μ}_{xv} )}^{2}}{2 {σ}_{xe}^{2} {σ}_{xv}^{2} ( 1 - {ρ}_{j}^{2} )} ] \qquad ( 1 )$$

In the considered situation:
μₓₑ=μₛ+μₙₑ
σₓₑ=\sqrt{σₛ²+σₙₑ²}
and
μₓᵥ=μₛμₙᵥ
σₓᵥ=\sqrt{σₛ²+σₙᵥ²}
Two new variables are introduced in order to simplify the calculations:

$$\tilde{{X}_{e}} = \frac{{X}_{e} - {μ}_{s} - {μ}_{ne}}{\sqrt{{σ}_{s}^{2} + {σ}_{ne}^{2}}}$$

$$\tilde{{X}_{v}} = \frac{{X}_{v} - {μ}_{s} - {μ}_{nv}}{\sqrt{{σ}_{s}^{2} + {σ}_{v}^{2}}}$$

The bivariate Gaussian probability density function under hypothesis Hⱼ for these variables is in the form:

$${f}_{j} ( {\tilde{X}}_{e} , \tilde{{X}_{v}} ) = \frac{1}{2 π \sqrt{1 - {ρ}_{j}^{2}}} \times exp [ - \frac{{\tilde{X}}_{e}^{2} - 2 {ρ}_{j} {\tilde{X}}_{e} {\tilde{X}}_{v} + {\tilde{X}}_{v}^{2}}{2 ( 1 - {ρ}_{j}^{2} )} ] \qquad ( 2 )$$

In hypothesis H₀, sₖ and s_{q} are independently drawn from the random variable S, which means that \tilde{X}ₑ and \tilde{X}ᵥ are also independent and that ρ₀=0. The probability density function ƒ₀ is hence given by:

$${f}_{0} ( {\tilde{X}}_{e} , {\tilde{X}}_{v} ) = \frac{1}{2 \cdot π} * exp [ - \frac{{\tilde{X}}_{e}^{2} + {\tilde{X}}_{v}^{2}}{2} ] \qquad ( 3 )$$

In hypothesis H₁, \tilde{X}ₑ and \tilde{X}ᵥ are correlated and the correlation coefficient ρ₁ is written:

$${ρ}_{1} = ρ = \frac{{σ}_{s}^{2}}{\sqrt{{σ}_{s}^{2} + {σ}_{ne}^{2}} \sqrt{{σ}_{s}^{2} + {σ}_{nv}^{2}}}$$

The probability density function ƒ₁ is hence given by:

$${f}_{1} ( {\tilde{X}}_{e} , {\tilde{X}}_{v} ) = \frac{1}{2 \cdot π \cdot \sqrt{1 - {ρ}^{2}}} * exp [ - \frac{{\tilde{X}}_{e}^{2} - 2 ρ \cdot {\tilde{X}}_{e} \cdot {\tilde{X}}_{v} + {\tilde{X}}_{v}^{2}}{2 ( 1 - {ρ}^{2} )} ] \qquad ( 4 )$$

Using (3) and (4), the likelihood ratio can be written as follows:

$$Λ ( {\tilde{X}}_{e} , {\tilde{X}}_{v} ) = \frac{( 1 / \sqrt{1 - {ρ}^{2}} ) exp [ - ( {\tilde{X}}_{e}^{2} - 2 ρ {\tilde{X}}_{e} {\tilde{X}}_{v} + {\tilde{X}}_{v}^{2} ) / 2 ( 1 - {ρ}^{2} ) ]}{exp [ - ( {\tilde{X}}_{e}^{2} + {\tilde{X}}_{v}^{2} ) / 2 ]}$$

and the logarithm of the likelihood ratio can be written as follows:

$$ln Λ ( {\tilde{X}}_{e} , {\tilde{X}}_{v} ) = - \frac{1}{2} ln ( 1 - {ρ}^{2} ) - \frac{{\tilde{X}}_{e}^{2} - 2 ρ {\tilde{X}}_{e} {\tilde{X}}_{v} + {\tilde{X}}_{v}^{2}}{2 ( 1 - {ρ}^{2} )} + \frac{{\tilde{X}}_{e}^{2} + {\tilde{X}}_{v}^{2}}{2} \\ ln Λ ( {\tilde{X}}_{e} , {\tilde{X}}_{v} ) = - \frac{1}{2} ln ( 1 - {ρ}^{2} ) - \frac{{{ρ}^{2} ( \tilde{{X}_{e}} - {\tilde{X}}_{v} )}^{2}}{2 ( 1 - {ρ}^{2} )} + \frac{ρ \tilde{{X}_{e}} \tilde{{X}_{v}}}{1 + ρ} \qquad ( 5 )$$

Logarithm of the Likelihood Ratio for Vectors of Identically Gaussian Distributed Scalars

In practice the signals sₖ, s_{q}, nₑ and nᵥ can be modeled as vectors of independent identically distributed scalars, which means that:
sₖ=[s_{k,1},s_{k,2}, . . . ,s_{k,m}] with s_{k,i}εP_{S} for i=1, . . . ,m
s_{q}=[s_{q,1},s_{q,2}, . . . ,s_{q,m}] with s_{q,i}εP_{S} for i=1, . . . ,m
nₑ=[n_{e,1},n_{e,2}, . . . ,n_{e,m}] with n_{e,i}εP_{Ne} for i=1, . . . ,m
nᵥ=[n_{v,1},n_{v,2}, . . . ,n_{v,m}] with n_{v,i}εP_{Nv} for i=1, . . . ,m
where m is the vector length and bold characters are used to refer to vectors.

The probability density function of independent identically distributed sequences is the product of the probability density for each element of the sequence.

Therefore, the logarithm of the likelihood ratio for vectors of Gaussian distributed scalars can be derived from (5) as follows:

$$ln Λ ( {\tilde{X}}_{e} , {\tilde{X}}_{v} ) = {\sum }_{i = 1}^{m} \{ - \frac{1}{2} ln ( 1 - {ρ}^{2} ) - \frac{{{ρ}^{2} ( {\tilde{X}}_{e , i} - {\tilde{X}}_{v , i} )}^{2}}{2 ( 1 - {ρ}^{2} )} + \frac{ρ \cdot {\tilde{X}}_{e , i} \cdot {\tilde{X}}_{v , i}}{1 + ρ} \} \qquad ( 6 )$$

It can be seen from equation (6) that the proposed decision function is a linear weighted function based on both a correlation term (\tilde{X}_{e,i.}\tilde{X}_{v,i}) and a squared difference term ((\tilde{X}_{e,i}−\tilde{X}_{v,i})²).

The signal to noise ratio in the enrollment phase is defined as the ratio of σₛ² to σₙₑ² The signal to noise ratio in the verification phase is defined as the ratio of σₛ² to σₙᵥ². When ρ is close to 0, that is when the signal to noise ratio is low, the correlation term is dominant in equation (6). When ρ is close to 1, that is when the signal to noise ratio is high, the squared difference term is dominant.

The performance of the verifier can be given in terms of the EER (Equal Error Rate), which is the value of FRR (False Rejection Rate; hypothesis H₀ chosen when hypothesis H₁ is true) and FAR (False Acceptance Rate; hypothesis H₁ chosen when hypothesis H₀ is true) if the decision threshold is chosen such that FRR=FAR.

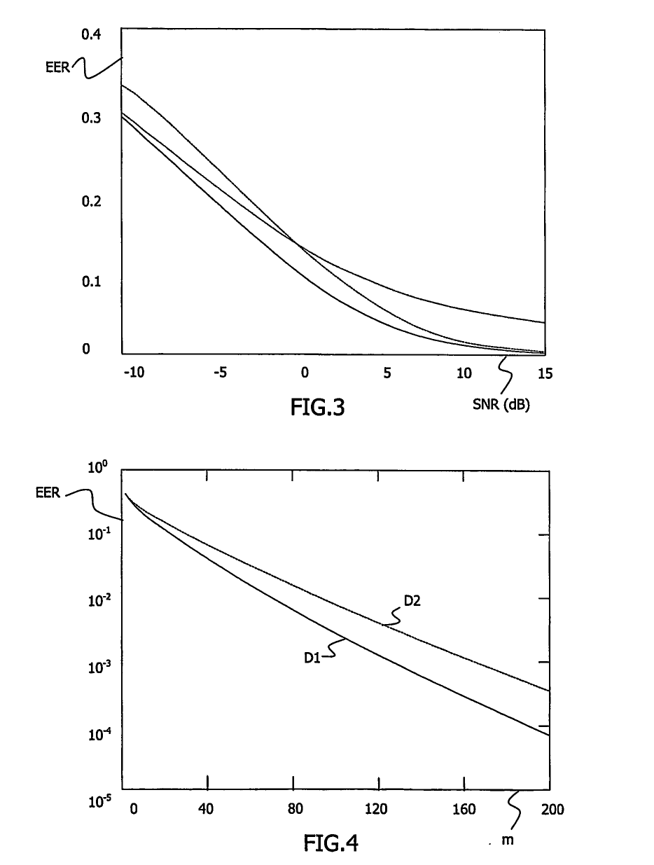

FIG. 3 gives the EER obtained as a function of the signal to noise ratio (SNR) when the vector length is m=20, with the proposed verifier (curve C1), with a verifier based on a correlation only (curve C2) and with a verifier based on a squared difference term only (curve C3). It is supposed here that the signal to noise ratio SNR is the same in the enrolement phase and in the verification phase, that is to say:

$$SNR = \frac{{σ}_{s}^{2}}{{σ}_{ne}^{2}} = \frac{{σ}_{s}^{2}}{{σ}_{nv}^{2}}$$

It can be seen from FIG. 3 that the performance of the verifier according to the invention is significantly better.

FIG. 4 gives the EER as a function of the vector length m when the signal to noise ratio SNR is equal to 0 dB. It is clear from FIG. 3 that, for a signal to noise ratio of 0 dB, the performance obtained with the verifier based on the correlation only and with the verifier based on the squared difference only are identical. Curve D1 gives the EER as a function of m for the verifier according to the invention. Curve D2 gives the EER as a function of m for the verifier based either on the correlation or on the squared distance. It can be seen from FIG. 4 that the improvement achieved with the invention is all the more important as the vector length m is greater.

FIG. 5 is a schematic representation of a system comprising an identification device 10 and a reader 12 for reading the identification device 10. The identification device represented in FIG. 5 is a smart card comprising a processor 14 and memory means 16 for storing an enrollment measurement xₑ and a program PG comprising code instructions for implementing a verification method according to the invention when said program is executed by the processor 14.

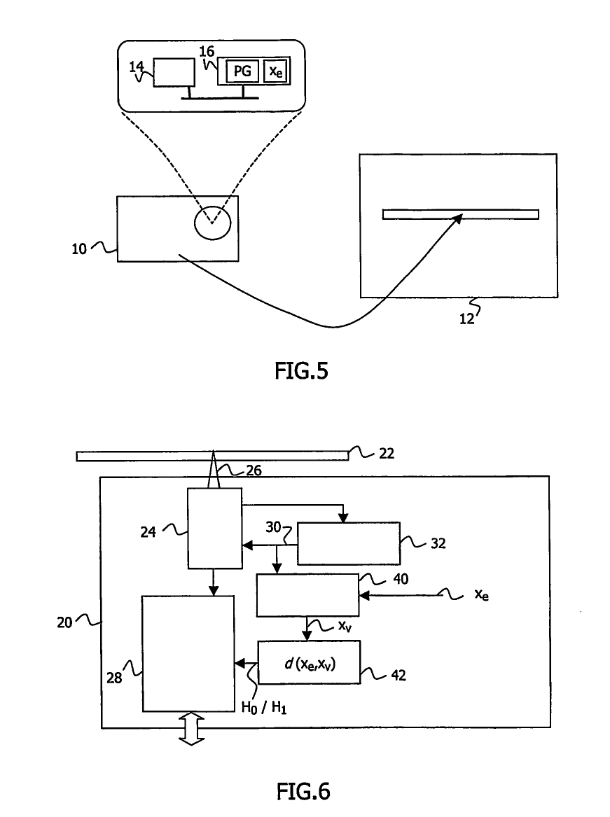

FIG. 6 is a schematic representation of an example of a reading/writing device according to the invention. The reading/writing device represented in FIG. 6 is an optical device 20 for reading/writing data from/onto an optical disc 22.

The reading/writing device 20 comprises an optical unit 24 that produces a radiation beam 26 intended for scanning a track printed on the optical disc 22, and a processing unit 28. The processing unit 28 is responsible for the encoding/decoding of the signals that are read/to be written by the optical unit 24 and for controlling the operations of the reading/writing device 20.

The track printed on the disc has the form of a spiraling line having a continuous sinusoidal deviation from its average center. The track shape is advantageously used as a “fingerprint” of the optical disc 22. For example, the track shape may be described by a series of complex values representative of each harmonic of the track deviation.

For tracking and focusing of the radiation beam 26, the optical unit 24 is controlled by a control signal 30 produced by a servo control unit 32. A measurement of the track shape can be derived from the control signal 30.

According to the invention, the reading/writing device 20 comprises a disc fingerprint calculation unit 40 and a verification unit 42. The disc fingerprint calculation unit 40 receives the control signal 30 generated by the servo control unit 32 and produces a measurement referred to as disc fingerprint. The disc fingerprint calculation unit 40 is used in the verification phase to produce a verification measurement xᵥ which characterizes a disc q. In the verification phase, the verification unit 42 receives the verification measurement xᵥ produced by the disc fingerprint calculation unit 40 and an enrollment measurement xₑ. It calculates the value d(xₑ,xᵥ) of the decision function d for xₑ and xᵥ and outputs a decision H₀/H₁. The decision H₀/H₁ is forwarded to the processing unit 28 for subsequent action.

The enrollment measurement xₑ may be produced by the disc fingerprint calculation unit 40 during the enrollment phase and stored in a memory of the reading/writing device 20 for future use by the verification unit 42. Alternatively, the enrollment measurement xₑ may be provided to the verification unit 42 through an independent input of the reading/writing device 20. It may be stored, for example, on the disc during the manufacturing process and read when the disc is inserted into the reading/writing unit 20.

For verifying the identity of an optical disc by using the spectral components of the track deviation, the distributions used for modelling the random variable S, the enrollment, noise and the verification noise are advantageously Gaussian distributions.

With respect to the described verification method, identification unit, and reading/writing device, modifications or improvements may be proposed without departing from the scope of the invention. The invention is thus not limited to the examples provided.

In particular, the invention is not restricted to the use of a logarithmicfunction or to the use of Gaussian distributions. The proposed decision function may be used to identify objects other than smart card users or record media. The invention applies to types of record media other than optical discs.

The verification method of the invention may use a single physical characteristic or several physical characteristics at the same time. When several physical characteristics are used, these characteristics are processed as a vector.

In the above description, the logarithm of the likelihood ratio has been derived for vectors of identically distributed scalars. This is not restrictive. The invention also applies when the components of the vectors are drawn from different distributions.

The use of the verb “comprise” does not exclude the presence of other elements or steps than those listed.

1. A verification method for verifying the identity of an object from a verification measurement which characterizes said object, and from a pre-stored enrollment measurement, wherein the enrollment measurement and the verification measurement are modeled as a first and a second realization of a first random variable affected by an enrollment noise and a verification noise, respectively, said enrollment noise being a realization of a second random variable, said verification noise being a realization of a third random variable, said first, second and third random variables having known distributions,
said verification method comprising the steps of:
calculating, for said enrollment measurement and said verification measurement, the value of a function of the ratio of a bivariate joint probability density function under a first hypothesis and a second hypothesis, said first hypothesis being that said first and second realizations of the first random variable are the same, said second hypothesis being that said first and second realizations are different,
taking a decision whether or not the enrollment measurement and the verification measurement are from the same object by comparing the calculated value with a threshold value.

2. A verification method as claimed in claim 1, wherein said function is a logarithmic function.

3. A verification method as claimed in claim 1, wherein said known distributions are Gaussian distributions.

4. An identification device intended to receive a verification measurement which characterizes a user, said identification device comprising:
storage means for storing an enrollment measurement,
verification means for verifying the identity of said user from said verification measurement and said enrollment measurement,
wherein the enrollment and the verification measurements are modeled as a first and a second realization of a first random variable affected by an enrollment noise and a verification noise respectively, said enrollment noise being a realization of a second random variable, said verification noise being a realization of a third random variable, said first, second and third random variables having known distributions,
and said verification means comprising:
means for calculating, for said enrollment measurement and said verification measurement, the value of a function of the ratio of a bivariate joint probability density function under a first hypothesis and under a second hypothesis, said first hypothesis being that said first and second realizations of the first random variable are the same, said second hypothesis being that said first and second realizations are different,
means for taking a decision whether or not the enrollment measurement and the verification measurement are from the same object by comparing the calculated value with a threshold value.

5. An identification device as claimed in claim 4, wherein said measurements are measurements of a physiological or a behavioral characteristic of said user.

6. An identification device as claimed in claim 4, wherein said known distributions are Gaussian distributions.

7. A smart card comprising an identification device as claimed in claim 4.

8. A reading/writing device for reading and/or writing data from/onto a record medium, said reading/writing device having:
measurement means for generating a measurement which characterizes a record medium, said measurement uniquely identifying said record medium,
verification means for verifying the identity of a record medium from a verification measurement which characterizes said record medium and an enrollment measurement,
wherein the enrollment and the verification measurements are modeled as a first and a second realization of a first random variable affected by an enrollment noise and a verification noise, respectively, said enrollment noise being a realization of a second random variable, said verification noise being a realization of a third random variable, said first, second and third random variables having known distributions,
and said verification means comprise:
means for calculating, for said enrollment measurement and said verification measurement, the value of a function of the ratio of a bivariate joint probability density function under a first hypothesis and under a second hypothesis, said first hypothesis being that said first and second realizations of the first random variable are the same, said second hypothesis being that said first and second realizations are different,
decision means for taking a decision whether or not the enrollment measurement and the verification measurement are from the same record medium by comparing the calculated value with a threshold value.

9. A reading/writing device as claimed in claim 6, comprising a reading/writing unit and control means for generating a control signal that is intended to control said reading/writing unit, wherein said measurement means comprise processing means for generating a set of values representing the frequency spectrum of said control signal when reading/writing data from/onto a record medium, said set of values constituting the measurement characterizing said record medium.

10. A program comprising code instructions for implementing a verification method as claimed in claim 1 when said program is executed by a processor.
